(19) United States
(12) Patent Application Publication
(10) Pub. No.: US 2025/0073834 A1
(43) Pub. Date: Mar. 6, 2025

(54) NUMERICALLY CONTROLLED MACHINE TOOL COMPRISING A MULTI-SPINDLE TURRET AND TOOL GRIPPING DEVICE

(71) Applicant: ETA SA Manufacture Horlogère Suisse, Grenchen (CH)

(72) Inventors: Patric PHAM, Utzenstorf (CH); Christophe DONZÉ, Pieterlen (CH)

(73) Assignee: ETA SA Manufacture Horlogère Suisse, Grenchen (CH)

(21) Appl. No.: 18/811,006

(22) Filed: Aug. 21, 2024

(30) Foreign Application Priority Data
Sep. 1, 2023 (EP) 23194901.7

(51) Int. Cl. B23Q 3/155

(52) U.S. Cl. CPC B23Q 3/15506; B23Q 2003/15537

(57) ABSTRACT

A numerically controlled machine tool including a multi-spindle turret provided with a body extending along an axis A-A between a first end by which it is fastened to a frame of the machine tool and a second end at which it comprises a rotatable head, the head comprising at least two toolholding spindles, each intended to engagingly receive a cutting tool, the spindles occupying, depending on the angular position of the head, a working position in which they are intended to carry out a machining operation on a workpiece held in position in a fixture, or a standby position in which they are withdrawn from said workpiece, each of said spindles being configured to be controlled independently of the other in order to immobilise or rotatably drive the tool that it carries, regardless of the position occupied thereby.

### CROSS REFERENCE TO RELATED APPLICATIONS

This application claims priority to European Patent Application No. 23194901.7 filed Sep. 1, 2023, the entire contents of which are incorporated herein by reference.

### TECHNICAL FIELD OF THE INVENTION

The invention relates to the field of numerically controlled machine tools for machining workpieces, preferably micromechanical workpieces, and to the field of equipment for such machines.

More specifically, the invention relates to a numerically controlled machine tool comprising a multi-spindle turret and a tool gripping device.

### TECHNOLOGICAL BACKGROUND

Numerically controlled machine tools are intended to produce mass-produced parts, in particular by machining, following the instructions of a computer programme. These machines comprise a tool mounted in a tool-holding spindle and are typically equipped with a tool changer to exchange the tool held by the tool-holding spindle in order to adapt it to the machining operations to be carried out on the workpiece held in position in a fixture.

During a tool change, the machine tool is no longer productive, which means that machining operations are interrupted. The aim is thus to minimise the time required to change tools. To this end, tool changers have been developed to work as much as possible concurrently with machining operations and to minimise machine tool downtime in order to increase the productivity thereof.

For example, multi-spindle turrets are known to comprise a head on which a plurality of tool-holding spindles are arranged, one of which is active, the others being at rest. In particular, the active tool-holding spindle is engaged with a drive mechanism by means of a coupling system. Thus, between two machining operations, tools can be changed by uncoupling the active tool-holding spindle, i.e. the one carrying the tool to be changed, rotating the head so as to present the next tool-holding spindle and coupling this tool-holding spindle to the drive mechanism.

However, this solution is not entirely satisfactory in that, although tool change times are reduced, they are not carried out entirely concurrently with machining operations. More specifically, between each tool change, with this type of multi-spindle turret, the tool to be changed must be braked before carrying out the tool change, and the next tool must be accelerated once it has been coupled to the drive mechanism, until it reaches its rotary machining speed. These multi-spindle turrets also require a certain amount of time to uncouple the tool to be changed, pivot the head and index the next tool to align it with the coupling system, and then perform the coupling. This solution is also particularly complex and expensive as a result of the coupling system.

Multi-spindle turrets solve the problem of accelerating and braking the tool-holding spindle, in which the tools are all driven rotatably and synchronously. Therefore, when the tools are changed, the next tool is already driven at its rotary machining speed and can start machining the workpiece. However, these multi-spindle turrets require large amounts of energy to rotate all of the tools simultaneously. Moreover, the maximum rotary speed of the tools they carry is relatively limited due to the motion transmission kinematic chain.

Overall, regardless of whether they rotate the tools they carry individually or simultaneously, the multi-spindle turrets of the prior art are bulky, which generates high moments of inertia and increases the risk of collision between the fixture and the tools carried by the turret.

In addition to the above-mentioned drawbacks, it is understood that these solutions are not suitable for machining micromechanical workpieces.

### SUMMARY OF THE INVENTION

The invention overcomes the aforementioned drawbacks by offering a solution that allows tools to be changed and replaced entirely concurrently with machining operations, in particular by carrying out the tool acceleration and deceleration phases concurrently with machining operations, and by engaging the multi-spindle turret with the tool gripping device concurrently with machining operations.

To this end, the present invention relates to a numerically controlled machine tool comprising a multi-spindle turret provided with a body extending along an axis A-A between a first end by which it is fastened to a frame of the machine tool and a second end at which it comprises a rotatable head. The head comprises at least two tool-holding spindles, each intended to engagingly receive a cutting tool, the spindles occupying, depending on the angular position of the head, a working position in which they are intended to carry out a machining operation on a workpiece held in position in a fixture, or a standby position in which they are withdrawn from said workpiece. Each of the spindles is configured to be controlled independently of the other in order to immobilise or rotatably drive the tool that it carries, regardless of the position occupied by the spindle. The machine tool further comprises a tool gripping device configured to interact with a spindle in a standby position in order to extract a tool carried by said spindle for the storage thereof, and in order to insert a replacement tool into said spindle.

As the spindles are controlled independently, they can be accelerated and decelerated concurrently with machining operations. The present invention thus allows tools to be changed with a non-productivity time reduced only to the duration of the rotation of the head until the next tool comes into contact with the workpiece, while making it possible to replace a tool, concurrently with a machining operation, on a spindle in the standby position.

In particular embodiments, the invention can further include one or more of the following features, which must be considered singly or according to any combination technically possible.

In particular embodiments, the gripping device comprises a tool magazine held in a cantilevered position by a support structure fastened to the body of the turret. The magazine comprises a storage barrel with a degree of rotational freedom about an axis C-C.

In particular embodiments, the magazine is configured so that the axis C-C is parallel to a longitudinal axis B′-B′ or B″-B″ of the spindle with which it interacts, said storage barrel and said spindle being translatable relative to each other along the axis C-C.

In particular embodiments, the magazine has at least one degree of translational or rotational freedom allowing it to move between:
an active position in which it is in the immediate vicinity of the spindle with which it is configured to interact, and
a disengaged position in which it is further away from the axis A-A than when it is in the active position.

In particular embodiments, the support structure comprises a joining member fastened to the body of the turret and connected to the magazine by an arm, said arm being configured to move the magazine between its active and disengaged positions.

In particular embodiments, the arm has a distal portion fastened to the magazine connected by a slide or pivot to a proximal portion fastened to the joining member.

In particular embodiments, the machine tool comprises at least two spindles occupying a standby position, the joining member being fastened to the body of the turret so as to be rotatable about the axis A-A, in order to drive the magazine from one spindle occupying the standby position to the other.

In particular embodiments, the magazine has a degree of translational mobility along an axis parallel to the axis A-A relative to the joining member, so as to move said magazine further away from the turret head when it occupies the disengaged position.

In particular embodiments, the joining member is fastened to the body of the turret so that it can slide along the axis A-A, so as to move said magazine further away from the head of the turret when it occupies the disengaged position.

In particular embodiments, the magazine comprises a protective casing provided with a slot comprising an axial portion and a radial portion allowing both the spindle and the tool to be stored to be inserted into the magazine, and allowing said magazine to be disengaged once the tool has been replaced.

In particular embodiments, the radial portion of the slot is shaped to match the shape of the spindle when the tool is replaced.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a perspective view of a multi-spindle turret according to a preferred example embodiment of the invention, with a tool gripping device capable of replacing tools carried by one or more spindles of the turret;

FIG. 2 shows a view of the turret shown in FIG. 1, oriented along the longitudinal axis of the body of the turret;

FIG. 3 shows a perspective view of the turret in FIG. 1 comprising a smaller tool gripping device, said figure revealing certain degrees of possible mobility of the tool gripping device.

It should be noted that the figures are not necessarily drawn to scale for clarity purposes.

### DETAILED DESCRIPTION OF THE INVENTION

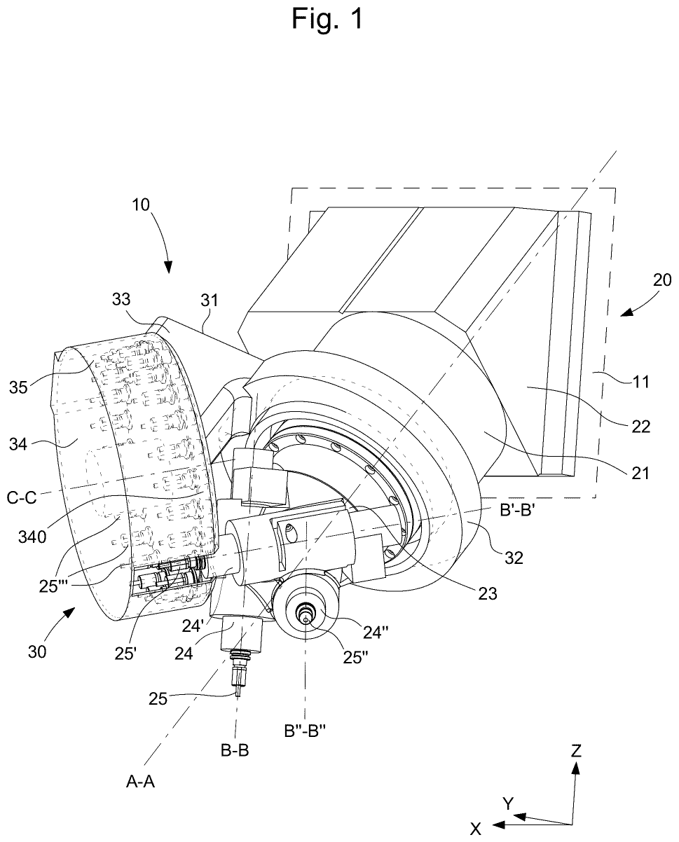

The present invention relates to a numerically controlled machine tool 10 comprising, as shown in FIG. 1, a multi-spindle turret 20 for machining preferably micromechanical workpieces and a tool gripping device 30.

The turret 20 comprises a body 21 extending along a longitudinal axis, referred to as the “A-A axis”, comprising at one of its ends a base 22 for fastening to a frame 11 of the machine tool 10 and at the other end a head 23 which can rotate about an axis coincident with the axis A-A in the example embodiment of the invention shown in the figures.

The head 23 comprises at least two tool-holding spindles 24, 24′ or 24″, each intended to engage a tool 25, 25′ or 25″. Depending on the angular position of the head 23, each spindle 24, 24′ and 24″ occupies a working position, in which it is intended to perform a machining operation on a workpiece held in position in a fixture, or a standby position, in which it is withdrawn from the workpiece. In FIGS. 1 to 4, the turret 20 comprises three spindles 24, 24′ and 24″, one of which is in the working position and two of which are in the standby position. It is understood here that rotation of the head 23 causes the tools to be changed, the tool 25 occupying the working position being moved into a standby position and one of the tools 25′ or 25″ in the standby position being moved into the working position.

It should be noted that the turret 20 can be driven translatably, for example if the base 22 is fastened to a carriage of the machine tool 10 (not shown in the figures) which can move with at least one degree of translational freedom, preferably with three degrees of translational freedom with reference to an XYZ trihedron.

Alternatively, the turret 20 can be unmoving, for example if the base 22 is fastened directly to the frame 11 of the machine tool 10. The fixture is thus provided with the aforementioned degrees of freedom, for example three degrees of translational freedom, respectively in the directions X, Y and Z and optionally one or two degrees of rotational freedom about X and/or Y.

The spindles 24, 24′ and 24″ are advantageously configured so that they can be controlled independently of each other in order to rotate or immobilise the tool 25, 25′ or 25″ carried thereby. This feature is particularly advantageous when changing tools. Preferably, the spindles 24, 24′ and 24″ are motorised spindles, also referred to as “electric spindles”, and each comprises its own motor for rotating or immobilising the tool 25, 25′ or 25″ carried thereby.

In particular, in order to replace a first tool 25 performing a first machining phase, with a second tool 25′ or 25″ intended to perform a second machining phase, the latter is driven rotatably, before the end of the first machining phase, until it reaches a speed of rotation specific to the second machining phase.

The first tool 25 is engaged in the spindle 24 in the working position and the second tool 25′ or 25″ is engaged in one of the spindles 24′ or 24″ in the standby position.

Once the first machining phase has been completed, the head 23 is pivoted so as to drive the spindle 24, which was in the work position, into the standby position, and so as to drive the spindle 24′ or 24″, which was in the standby position, into the work position. The second machining phase then begins immediately, thanks to the fact that the second tool 25′ or 25″ reached its rotary machining speed when the spindle 24′ or 24″ in which it is engaged was in the standby position. With the spindle 24 carrying the first tool 25 now in the standby position, the rotational motion thereof is stopped.

Thus, as the second tool 25′ or 25″ is rotated and the first tool 25 is stopped from rotating concurrently with the machining operations, the tools are changed with a non-productivity time that is reduced only to the duration of the rotation of the head 23 along the axis A-A.

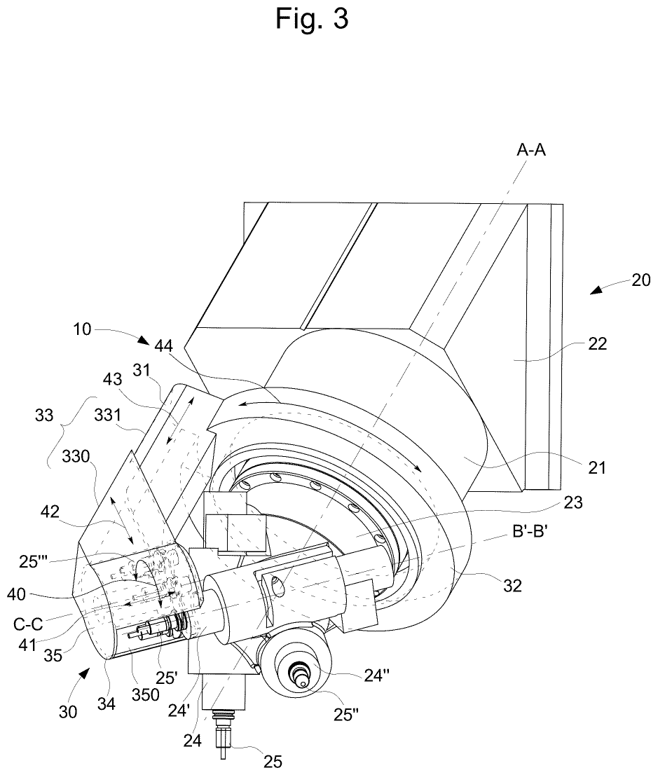

Each spindle 24, 24′ and 24″ extends respectively along a longitudinal axis, referred to as the “axis B-B”, “axis B′-B” and “axis B”-B″, also constituting their axis of rotation, as illustrated in FIG. 1. As can be seen in FIGS. 1 and 3, in the working position, the spindle 24 is preferably oriented so that its axis B-B is parallel to a vertical axis.

Advantageously, the present invention makes it possible to replace a tool 25′ or 25″ to be stored, during the performance of a machining operation, which tool is carried by one of the spindles 24′ or 24″ in a standby position and not rotating. More specifically, the machine tool 10 comprises a tool gripping device 30 capable of extracting the tool 25′ or 25″ to be stored from a spindle 24′ or 24″ and of inserting a new tool, referred to as the “replacement tool” 25″, into said spindle 24′ or 24″, as described below.

The gripping device 30 is fastened to the body 21 of the turret 20, as shown in FIGS. 1 to 3, for example if the base 22 is fastened to a carriage that can move relative to the frame 11.

As can be seen from FIGS. 1 to 3, the gripping device 30 comprises a tool magazine 34 held in a cantilevered manner by a support structure 31. The magazine 34 comprises a tool storage barrel 340 comprising a plurality of recesses 341 intended to receive replacement tools 25″ or replaced tools. In particular, the recesses 341 can each comprise a radially-open opening through which they are able to engagingly receive a replacement tool 25″ or a replaced tool.

In this example, the storage barrel 340 can take the form of a disc with the recesses 341 evenly distributed around its periphery.

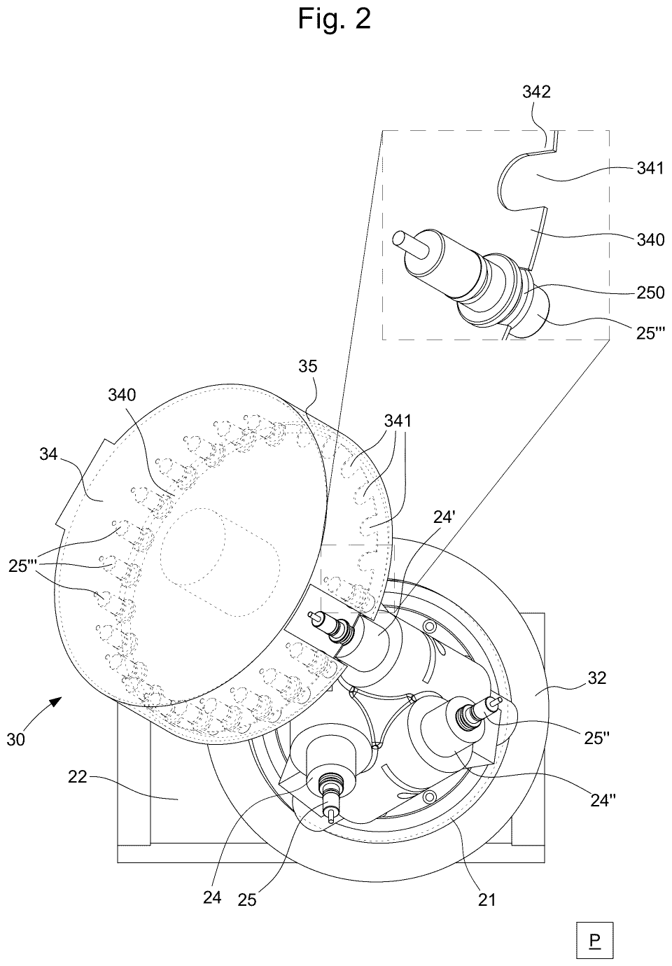

Each recess 341 can comprise a gripping member formed by a clamp 342, shown diagrammatically in the detailed view in FIG. 2. Each clamp 342 has elastic deformation properties such that it is able to engagingly receive a tool and hold it in position in the recess 341 by friction. In particular, the tools can comprise an annular groove 250 in which the clamp 342 is intended to engage. It should be noted that such elastic clamps are known to a person skilled in the art and their design is within the abilities thereof.

In the example embodiment of the invention shown in FIGS. 1 to 3, the storage barrel 340 has a degree of rotational freedom about an axis C-C parallel to the axis B′-B′ or the axis B″-B″ of one of the spindles 24′ or 24″ in the standby position, in particular the spindle 24′, with which it interacts, so as to be able to bring each of the recesses 341 that it comprises to face said spindle 24′. This degree of freedom is represented by the arrow 40 in FIG. 3.

The storage barrel 340 and said spindle 24′ with which it interacts can also move translatably relative to each other along an axis parallel to the axis B′-B′ of the spindle 24′. This relative mobility is preferably ensured by a degree of translational freedom of the storage barrel 340 along the axis C-C, as shown by the arrow 41 in FIG. 3. Alternatively, this relative mobility can be ensured by a degree of translational freedom along the axis B′-B′ of the spindle 24′ in the standby position.

More specifically, in order to replace the tool 25′ engaged in the spindle 24′ in the standby position with a replacement tool 25″ disposed in the storage barrel 340, the latter is pivoted so as to bring an empty recess 341 to face the tool 25′ to be stored, then the storage barrel 340 is moved translatably towards said spindle 24′ so as to insert the tool 25′ to be stored into the recess 341. During this insertion of the tool 25′ to be stored into the recess 341, the clamp 342 thereof is deformed until it engages in the annular groove 250 of the tool 25′ to be stored. A translation of the storage barrel 340 in a direction opposite to the spindle 24′ then allows said tool 25′ to be removed for storage. In order to insert a replacement tool 25′″ into this spindle 24′, the storage barrel 340 is pivoted until the replacement tool 25′″ is aligned with the spindle 24′, then it is translated towards said spindle 24′ so as to engage said replacement tool 25′″ in said spindle 24′. A translational movement in a direction perpendicular to the axis B′-B′ allows the replacement tool 25′″ to be removed from the recess 341 in which it was disposed, said replacement tool 25′″ now being fastened in said spindle 24′.

It should be noted that, if the recesses 341 are arranged so that their opening opens tangentially or orthoradially relative to the storage barrel 340, the tool 25′ to be stored is engaged in a recess 341, and a replacement tool 25′″ is removed from a recess 341, by rotating the storage barrel 340 along the axis C-C, respectively in two opposite directions.

In a manner known per se to a person skilled in the art, during these operations, the spindle 24′ is controlled so as to release the tool 25′ to be stored when the storage barrel 340 is moved translatably in a direction opposite to the spindle 24′, and is configured so as to lock the replacement tool 25′″ when it is inserted therein.

Advantageously, the magazine 34 can have one or more degrees of translational or rotational freedom, allowing it to move between an active position and a disengaged position. In the active position, the magazine 34 is in the immediate vicinity of a spindle 24′ or 24″ in the standby position, in particular the spindle 24′, with which it is intended to interact so as to extract a tool 25′ to be stored, which tool is carried thereby or to insert a replacement tool 25′″ in said spindle 24′, as described previously. In the disengaged position, the magazine 34 is further away from the axis A-A, and thus from the head 23, than when it is in the active position. Such an arrangement prevents any risk of the magazine 34 colliding during a machining operation or when the head 23 is rotated to change tools.

To this end, the support structure 31 is configured to move the magazine 34 between its active and disengaged positions.

In particular, as shown in FIGS. 1 to 3, the support structure 31 can comprise a joining member 32 fastened to the body 21 of the turret 20 and connected to the magazine 34 by an arm 33. The arm 33 is configured to move the magazine 34 between its active and disengaged positions. In particular, the arm 33 can be configured so as to move the magazine 34 translatably along an axis substantially orthogonal to the axis B′-B′ of the spindle 24′ in the standby position with which the magazine 34 interacts, as shown by an arrow 42 in FIG. 3.

In this example embodiment, the degree of translational mobility of the magazine 34 along the axis substantially orthogonal to the axis B′-B′ of the spindle 24′ is provided by a distal portion 330 of the arm 33 fastened to the magazine 34 and connected by a slide to a proximal portion 331 fastened to the joining member 32.

Alternatively, in an example embodiment not shown in the figures, in order to move it between one and the other of its active and disengaged positions, the magazine 34 could pivot relative to the arm 33, about an axis of rotation parallel to the axis B′-B′ of the spindle 24′ with which it is intended to interact, the distal portion 330 thus being connected by a pivot to the proximal portion 331. It is understood here that the magazine is rotated in such a way as to drive the storage barrel 340 eccentrically, so as to move it away from or towards the spindle 24′ with which it is intended to interact.

Preferably, the joining member 32 is formed by a fastening ring arranged around the body 21 and fastened thereto so as to be rotatable about the axis A-A, as illustrated by the arrow 44 in FIG. 3. The shape of the fastening ring allows the forces involved to be distributed advantageously. This mobility makes it possible to move the magazine 34 so as to interact successively with all of the spindles 24′ and 24″ occupying a standby position, and as a result to be able to replace the tools 25′ and 25″ of these spindles without rotating the head 23 of the turret 20.

Advantageously, the magazine 34 can have a degree of translational mobility along an axis parallel to the axis A-A, relative to the joining member 32, by means of the arm 33, so as to move the magazine 34 further away from the head 23 when it is in the disengaged position. In particular, as illustrated diagrammatically in FIG. 3 by an arrow 43, the proximal portion 331 of the arm 33 can be fastened to the joining member 32 so as to be translatably movable along an axis parallel to the axis A-A.

Alternatively, the joining member 32 can be fastened to the body 21 of the turret 20 so that it can slide along the axis A-A.

In the example embodiment of the invention in which the turret is unmoving relative to the frame 11, the fixture has degrees of translational and rotational mobility suitable for executing a machining programme.

Advantageously, as can be seen in FIGS. 1 to 3, the magazine 34 comprises a protective casing 35 shown in these figures in the form of rigid walls having an axisymmetric shape. Due to the kinematics described above, the protective casing 35 comprises a slot 350 through which a tool 25′, 25″ or 25′″ can pass when the magazine 34 is moved.

In particular, the slot 350 comprises an axial portion and a radial portion allowing both the spindle 24′ and the tool 25′ to be stored to be inserted into the magazine 34, and allowing said magazine 34 to be disengaged once the tool 25′ or 25″ has been replaced. Advantageously, the radial portion of the slot 350 is shaped to match the shape of the spindle 24′ when the tool 25′ or 25″ is replaced.

More generally, it should be noted that the implementations and embodiments considered above have been described by way of non-limiting examples, and that other alternatives are consequently possible.

1. A numerically controlled machine tool (10), comprising a multi-spindle turret (20) provided with a body (21) extending along an axis A-A between a first end by which it is fastened to a frame (11) of the machine tool (10) and a second end at which it comprises a rotatable head (23), the head (23) comprising at least two tool-holding spindles (24, 24′, 24″), each intended to engagingly receive a cutting tool (25, 25′, 25″), the spindles (24, 24′, 24″) occupying, depending on the angular position of the head (23), a working position in which they are intended to carry out a machining operation on a workpiece held in position in a fixture, or a standby position in which they are withdrawn from said workpiece, each of said spindles (24, 24′, 24″) being configured to be controlled independently of the other in order to immobilise or rotatably drive the tool (25, 25′, 25″) that it carries, regardless of the position occupied thereby, the machine tool (10) further comprising a tool gripping device (30) configured to interact with a spindle (24′, 24″) in a standby position in order to extract a tool (25′, 25″) carried by said spindle (24′, 24″) for the storage thereof, and in order to insert a replacement tool (25′″) into said spindle (24′, 24″), the gripping device (30) comprising a tool magazine (34) held in a cantilevered position by a support structure (31) fastened to the body (21) of the turret (20), the magazine (34) comprising a storage barrel (340) with a degree of rotational freedom about an axis C-C.

2. The machine tool (10) according to claim 1, wherein the magazine (34) is configured so that the axis C-C is parallel to a longitudinal axis B′-B′ or B″-B″ of the spindle (24′, 24″) in the standby position with which it interacts, said storage barrel (340) and said spindle (24′, 24″) being translatable relative to each other along the axis C-C.

3. The machine tool (10) according to claim 1, wherein the magazine (34) has at least one degree of translational or rotational freedom allowing it to move between:
an active position in which it is in the immediate vicinity of the spindle (24′, 24″) with which it is configured to interact, and
a disengaged position in which it is further away from the axis A-A than when it is in the active position.

4. The machine tool (10) according to claim 3, wherein the support structure (31) comprises a joining member (32) fastened to the body (21) of the turret (20) and connected to the magazine (34) by an arm (33), said arm (33) being configured to move the magazine (34) between its active and disengaged positions.

5. The machine tool (10) according to claim 4, wherein the arm (33) has a distal portion (330) fastened to the magazine (34) connected by a slide or pivot to a proximal portion (331) fastened to the joining member (32).

6. The machine tool (10) according to claim 4, comprising at least two spindles (24′, 24″) occupying a standby position, the joining member (32) being fastened to the body (21) of the turret (20) so as to be rotatable about the axis A-A, in order to drive the magazine (34) from one of the spindles (24′, 24″) occupying the standby position to the other.

7. The machine tool (10) according to claim 4, wherein the magazine (34) has a degree of translational mobility along an axis parallel to the axis A-A relative to the joining member (32), so as to move said magazine further away from the turret head when it occupies the disengaged position.

8. The machine tool (10) according to claim 4, wherein the joining member (32) is fastened to the body (21) of the turret (20) so that it can slide along the axis A-A, so as to move said magazine further away from the head of the turret when it occupies the disengaged position.

9. The machine tool (10) according to claim 1, wherein the magazine (34) comprises a protective casing (35) provided with a slot (350) comprising an axial portion and a radial portion allowing both the spindle (24′, 24″) and the tool (25′, 25″) to be stored to be inserted into the magazine (34), and allowing said magazine (34) to be disengaged once the tool (25′, 25″) has been replaced.

10. The machine tool (10) according to claim 9, wherein the radial portion of the slot (350) is shaped to match the shape of the spindle (24′, 24″) when the tool (25′, 25″) is replaced.
